(19) United States
(12) Patent Application Publication
(10) Pub. No.: US 2005/0008285 A1
(43) Pub. Date: Jan. 13, 2005

(54) Multi-channel optical switch

(76) Inventors: Seon-ju Kim, Gwangju-si (KR); Ho-nam Kwon, Gwangju-si (KR); Jong-hyun Lee, Gwangju-si (KR); Won-hyo Kim, Gyesangnam-do (KR); Jong-sam Park, Gwangju-si (KR)

Correspondence Address: LADAS & PARRY LLP, 224 SOUTH MICHIGAN AVENUE, SUITE 1200, CHICAGO, IL, 60604, US

(21) Appl. No.: 10/843,062

(22) Filed: May 11, 2004

(30) Foreign Application Priority Data
Jun. 18, 2003 (KR) 10-2003-39300

(51) Int. Cl. G02B 6/26

(52) U.S. Cl. 385/18

(57) ABSTRACT

An optical switch enabling optical communications between an input port and an output port of an optical waveguide by minimizing loss error of an optical signal without using a collimator comprised of a separate mediate optical waveguide, lens or the like is provided. The multi-channel optical switch, which changes optical paths, includes four pairs of input optical waveguides and output optical waveguide arranged in parallel to each other, the first pair of input optical waveguide and output optical waveguide facing the second pair of input optical waveguide and output optical waveguide at an angle of 90 degrees, the first input optical waveguide being installed to correspond to the second output optical waveguide, four mirrors installed to enter in optical path directions between the four pairs of input optical waveguides and output optical waveguides, thereby changing the optical paths, and a mirror actuator for selectively operating the entering of the mirror.

### BACKGROUND OF THE INVENTION

1. Field of the Invention

The present invention relates to a multi-channel optical switch used in a wavelength division multiplex (WDM) optical communication system, and more particularly, to an optical switch enabling optical communications between an input port and an output port of an optical waveguide by minimizing loss error of an optical signal without using a collimator comprised of a separate mediate optical waveguide, lens or the like.

2. Description of the Related Art

Generally, multiple channel signals are transmitted by light with several wavelengths in the WDM optical fiber communication. Single mode fibers supporting light signals with the wavelength of 1.3 or 1.55 um are widely used for this optical fiber communication because of low transmission loss.

The apparatus for implementing the WDM is called ‘Wavelength division multiplexer’ and functions as a kind of optical coupler, which makes one optical fiber channel work multiple signal optical paths by the separation of the channel signals with respect to their wavelengths.

For example, light signals with wavelengths of 1.55 μm and 1.5 μm can be transmitted through one optical fiber. Each of wavelength signals has the individual information and is transmitted independently through the fiber.

There are two mechanisms for wavelength division multiplexer. One mechanism utilizes that the diffraction and reflection are varied by the wavelength and the other divides the channel by a fixed type or a variable type filter. In other words, there is used a principle in which one wavelength passes through a filter while the other wavelength is reflected.

The wavelength division multiplexer system uses an optical add/drop multiplexer. The optical add/drop multiplexer uses a MEMS (Micro Electro Mechanical Switch) type optical switch.

The MEMS type optical switches block light signals or change the optical paths. Micromachined optical switch is big issue because its usual insertion losses, crosstalk, wavelength dependent losses, polarization dependent losses are lower than any other switching mechanism.

1×2 and 2×2 optical switch are the fundamental mechanisms of micromachined optical switches, and the latter is more widely used. Optical waveguide is used as a light transmission path and is formed of conductive material in the shape of cylindrical or rectangular bar.

In the above multi-channel optical switch, an input port is formed at one end and an output port is formed at the other end. An add port and a drop port are formed perpendicular to the input port and the output port. The input port, the drop port, the add port and the drop port are arranged in a matrix configuration such that a mirror enters into a portion where lights emitted from the respective ports cross. Then, an interval between the channels (i.e., optical waveguides) cannot be decreased to a size less than a size of a micromachined actuator for driving the mirror. So, the related art optical switch should necessarily use the collimator composed of the optical waveguides, lens or the like so as to insertion loss between the ports.

FIG. 1 is a schematic view of a multi-channel optical switch according to a related art. Referring to FIG. 1, the multi-channel optical switch includes two input ports 111 and 112, two add ports 121 and 122, two output ports 211 and 212, two drop ports 221 and 222, and four mirrors 311, 312, 321 and 322. In the multi-channel optical switch, the same kinds of ports are arranged in parallel to each other. As the mirrors 311, 312, 321 and 322 emerge from an optical path or enter into the optical path and changes the advancing direction of the light, the lights emitted from the two input ports 111 and 112 and the two add ports 121 and 122 are selectively transferred to the two output ports 211 and 212 and the drop ports 221 and 222.

FIG. 2 illustrates a reflection separation 411 when light is reflected by the mirrors of the multi-channel optical switch of FIG. 1. As shown in FIG. 2, when the light is reflected by the mirror, the reflection separation 411 as much as 1/√2 of thickness of the mirror from a center axis of the light occurs due to the thickness of the mirror.

FIG. 3 illustrates reflection separations 411 and 412, and optical paths 510, 512, 514 and 516 when light is reflected by the multiple mirrors. The reflection separation increases as much as the number of the mirrors. In other words, the light is reflected separately by a distance 411 as much as 1/√2 of thickness of the first mirror by the first mirror, and the reflection separation is increased by a distance 412 as much as 2/√2 of thickness of the second mirror index matching, resulting in light transmission loss.

### SUMMARY OF THE INVENTION

Accordingly, this invention is devised to overcome the aforementioned problems of the related art switch mechanisms.

The present invention provides a multi-channel optical switch enabling optical communications between an input port and an output port of an optical waveguide by minimizing loss error of an optical signal without using a collimator comprised of a separate mediate optical waveguide, lens or the like.

To accomplish the object and other advantages, there is provided a multi-channel optical switch, which changes optical paths, comprising: a first input optical waveguide and a first output optical waveguide arranged in parallel to each other; a second input optical waveguide and a second output optical waveguide arranged in parallel to each other and spaced apart by a predetermined interval from the first input optical waveguide and the first output optical waveguide; a third input optical waveguide and a third output optical waveguide, and a fourth input optical waveguide and a fourth output optical waveguide arranged perpendicular to the first input optical waveguide and the first output optical waveguide, and the second input optical waveguide and the second output optical waveguide; mirrors configured to enter on paths between the first input optical waveguide through the fourth input optical waveguide and the first output optical waveguide through the fourth output optical waveguide; and a mirror actuator for selectively operating the entering of the mirrors.

Preferably, to decrease the insertion loss of the respective waveguides, the optical waveguide having an expanded core may be used, an end facet of each of the waveguides may be made in the form of lens, an antireflective film may be coated on the end facet of each of the waveguides, or a refractive index matching liquid, a separate optical waveguide or a lens may be provided between the waveguides. Also, to reduce reflection loss of the pairs of optical waveguides, refractive index matching liquid or antireflection coating may be provided to the end facet of each of the pairs of optical waveguides, or each of the optical waveguides may have a facet beveled at an angle of 3 degrees to 20 degrees.

### BRIEF DESCRIPTION OF THE DRAWINGS

FIG. 1 is a schematic view of a multi-channel optical switch according to a related art;

FIG. 2 illustrates a reflection separation when light is reflected by mirrors of the multi-channel optical switch of FIG. 1;

FIG. 3 illustrates optical paths when light is reflected by mirrors of the multi-channel optical switch of FIG. 1;

FIG. 4 is a schematic view of a multi-channel optical switch according to an embodiment of the present invention;

FIG. 5 illustrates optical paths when light is reflected by mirrors of the multi-channel optical switch of FIG. 4; and

FIG. 6 illustrates optical paths when light is reflected by mirrors of the multi-channel optical switch of FIG. 4.

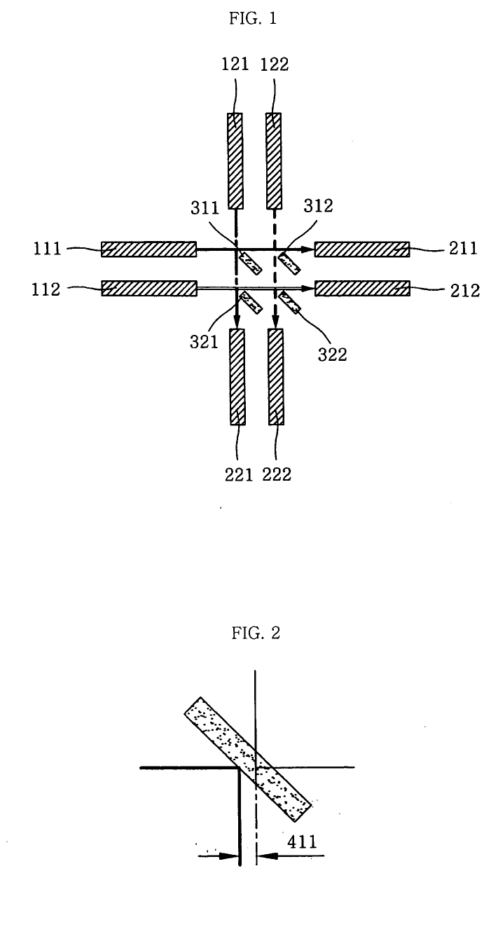

### DETAILED DESCRIPTION OF THE INVENTION

The present invention will now be described more fully with reference to the accompanying drawings, in which exemplary embodiments of the invention are shown

FIG. 4 is a schematic view of a multi-channel optical switch according to an embodiment of the present invention. Referring to FIG. 4, the multi-channel optical switch includes two pairs of input and output ports 111 and 212, and 211 and 112 for inputting and outputting light, two pairs of add and drop ports 121 and 222, and 221 and 122 for inputting and outputting light, mirrors 311, 312, 313 and 314, which enter or emerge in an optical path direction between the pairs of ports 111 and 212, 211 and 112, 121 and 222, and 221 and 122 to change the optical path direction, and a driving unit (not shown) for controlling the entering and emerging of the mirrors 311, 312, 313 and 314. The names or functions of the input port, the output port, the add port and the drop port may be changed according to their use.

In FIG. 4, the mirrors 311, 312, 313 and 314 enter or emerge in the optical path direction between the pairs of ports 111 and 212, 211 and 112, 121 and 222, and 221 and 122 by a driving unit, to change the optical path direction between the input and output ports 111 and 212, 211 and the add and drop ports 112, 121 and 222, and 221 and 122. For example, when all the mirrors 311, 312, 313 and 314 emerge from the optical paths, the optical paths have linearity. To the contrary, when all the mirrors 311, 312, 313 and 314 enter on the optical paths, the lights are reflected by the corresponding mirrors by 90 degrees and are directed toward the corresponding input ports. In other words, to decrease loss generated when an optical signal is transferred from one port to another port, the pairs of the respective waveguides are arranged in parallel to each other. It is desirable that the four pairs of optical waveguides are aligned with an angle of 90 degrees.

The respective mirrors 311, 312, 313 and 314 are disposed between the pairs of waveguides, and are aligned with an angle of 90 degrees with respect to each other. The four aligned mirrors selectively transfer optical signals outputted from the four input ports to the four output ports.

To decrease the insertion loss of the respective waveguides, an optical waveguide having an expanded core may be used, an end facet of each of the waveguides may be made in the form of lens, an antireflective film may be coated on the end facet of each of the waveguides, or a refractive index matching liquid, a separate optical waveguide or a lens may be provided between the waveguides. Also, to reduce reflection loss of the pairs of optical waveguides, refractive index matching liquid or antireflection coating may be provided to the end facet of each of the pairs of optical waveguides, or each of the optical waveguides may have a facet beveled at an angle of 3 degrees to 20 degrees.

The driving unit for driving the mirrors may be a comb teeth-type electrostatic actuator, a heat actuator, a piezoelectric actuator, a parallel plate type actuator or the like, which drives the mirrors in direction parallel to faces formed by the optical waveguides. Alternatively, the comb teeth-type electrostatic actuator, the heat actuator, the piezoelectric actuator, or the parallel plate type actuator may drive the mirrors fabricated vertically in parallel to the faces formed by the optical waveguides. Alternatively, the comb teeth-type electrostatic actuator, the heat actuator, the piezoelectric actuator, or the parallel plate type actuator may drive the mirrors fabricated horizontally in parallel to the faces formed by the optical waveguides. Alternatively, the comb teeth-type electrostatic actuator, the heat actuator, the piezoelectric actuator, or the parallel plate type actuator may position the mirrors fabricated vertically on the optical paths by rotating the mirrors.

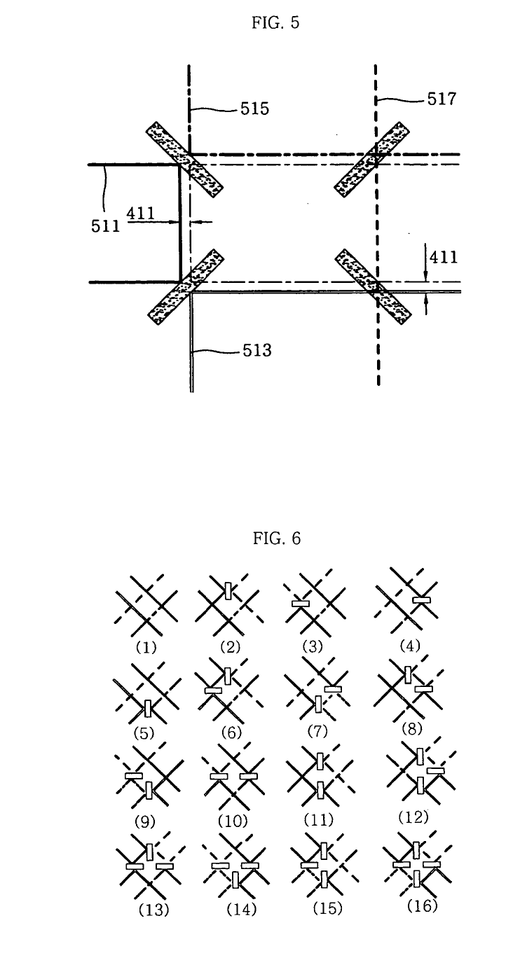

FIGS. 5 and 6 illustrate optical paths when light is reflected by mirrors of the multi-channel optical switch of FIG. 4.

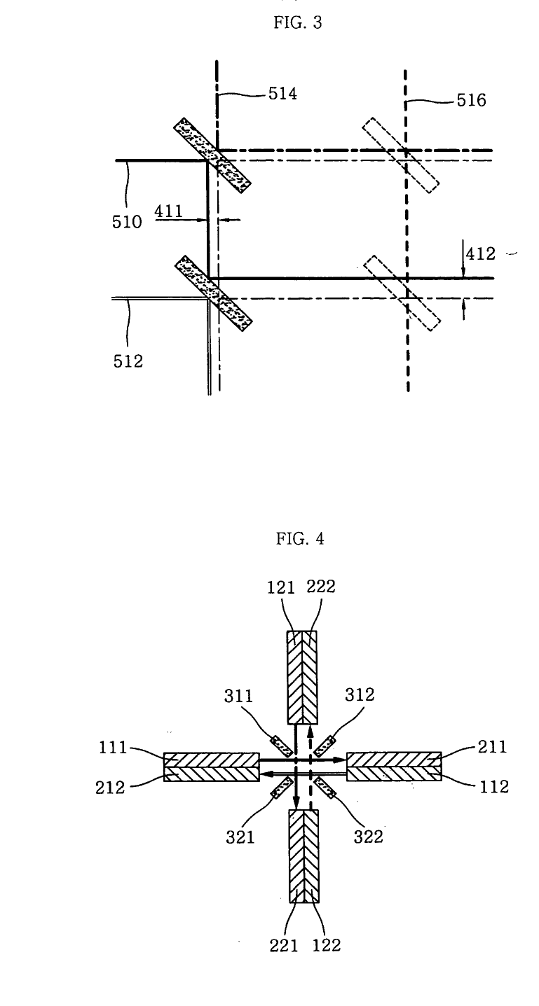

The related art optical switch shown in FIG. 3 has the drawback in that the separation deepens while the light is reflected by the several mirrors. However, in the inventive optical switch shown in FIG. 5, the reflection separation 411 as much as 1/√2 of the thickness of the mirror occurs, but is canceled by the symmetric property of the optical path when the light is reflected via the two mirrors. In other words, although the light is twice reflected by the first mirror and the second mirror, the reflection separation is not increased but is canceled.

Also, as shown in FIG. 3, the length of the optical path is varied depending on an operation of the mirrors. In particular, the optical path indicated by reference numeral 510 causes a path difference corresponding to the separation distance of the mirror, thereby causing light loss when compared with the optical path indicated by reference numeral 514. However, unlike in the related art, the optical path of the inventive optical switch indicated by reference numeral 511 of FIG. 5 is minimized or the optical paths 513 and 515 having a constant length are formed. In FIG. 6, 16 kinds of optical paths (1) through (16) are shown according to operations of the mirrors. At this time, the optical paths are minimized and constant, thereby minimizing light loss.

While the above embodiment exemplarily shows and describes that the number of the optical waveguides and the number of the mirrors are constant, the number of the optical waveguides and the number of the mirrors may be changed within a range that micromachining technology allows.

As described above, the invention provides a multi-channel optical switch enabling optical communications between an input port and an output port of an optical waveguide by minimizing loss error of an optical signal without using a collimator comprised of a separate mediate optical waveguide, lens or the like. According to the inventive multi-channel optical switch, since the optical paths between the input port and the output port are the same and the insertion loss is uniform, the inventive multi-channel optical switch does not need an optical attenuator.

While this invention has been particularly described with reference to preferred embodiments thereof, it will be understood by those skilled in the art that various changes in form and details may be made therein without departing from the spirit and scope of the invention as defined by the appended claims and equivalents thereof.

1. A multi-channel optical switch, which changes optical paths, comprising:
a first input optical waveguide and a first output optical waveguide arranged in parallel to each other;
a second input optical waveguide and a second output optical waveguide arranged in parallel to each other and spaced apart by a predetermined interval from the first input optical waveguide and the first output optical waveguide;
a third input optical waveguide and a third output optical waveguide, and a fourth input optical waveguide and a fourth output optical waveguide arranged perpendicular to the first input optical waveguide and the first output optical waveguide, and the second input optical waveguide and the second output optical waveguide;
mirrors configured to enter on paths between the first input optical waveguide through the fourth input optical waveguide and the first output optical waveguide through the fourth output optical waveguide; and
a mirror actuator for selectively operating the entering of the mirrors.

2. The multi-channel optical switch of claim 1, wherein each of the first input optical waveguide through the fourth input optical waveguide and the first output optical waveguide through the fourth output optical waveguide has an end facet coated with an antireflective film.

3. The multi-channel optical switch of claim 1, wherein a refractive index matching liquid is filled between the first input optical waveguide through the fourth input optical waveguide and the first output optical waveguide through the fourth output optical waveguide.

4. The multi-channel optical switch of claim 1, wherein each of the first input optical waveguide through the fourth input optical waveguide and the first output optical waveguide through the fourth output optical waveguide has an end facet shaped in a lens.

5. The multi-channel optical switch of claim 1, wherein the first input optical waveguide through the fourth input optical waveguide and the first output optical waveguide through the fourth output optical waveguide is beveled at an angle of 3 degrees to 20 degrees.

6. The multi-channel optical switch of claim 1, wherein each of the first input optical waveguide through the fourth input optical waveguide and the first output optical waveguide through the fourth output optical waveguide has a core, which is thermally expanded.
